(19) United States
(12) Patent Application Publication
(10) Pub. No.: US 2026/0132236 A1
(43) Pub. Date: May 14, 2026

(54) LIGHT ABSORBERS FOR OPHTHALMC LENS MATERALS AND DEVICES

(71) Applicant: Alcon Inc., Fribourg (CH)

(72) Inventors: Troy Vernon Holland, Suwanee, GA (US); Adam K. Sniady, Lilburn, GA (US); Frank Chang, Cumming, GA (US)

(21) Appl. No.: 19/383,953

(22) Filed: Nov. 10, 2025

Related U.S. Application Data
(60) Provisional application No. 63/718,851, filed on Nov. 11, 2024.

(51) Int. Cl. C08F 226/10; G02B 1/04

(52) U.S. Cl. CPC C08F 226/10; G02B 1/043

(57) ABSTRACT

Benzotriazole vinylic monomers having an increased solubility in ophthalmic device material formulations relative to certain other benzotriazole vinylic monomers are disclosed. Such benzotriazole vinylic monomers are useful for fabricating various ophthalmic devices including hydrogel contact lenses such as silicone hydrogel contact lenses and can have a high relative ultraviolet and/or High-energy visible light (UV/HEVL) absorption.

This application claims the benefits under 35 USC § 119 (e) of U.S. provisional application No. 63/718,851, filed on 11 Nov. 2024, incorporated by reference in its entirety.

### TECHNICAL FIELD

The present disclosure relates to a light absorbing benzotriazole compound that can be incorporated into materials for an ophthalmic device such as a contact lens. In particular, the present disclosure relates to ultraviolet and/or high-energy visible light (UV/HEVL)-absorbing benzotriazole vinylic monomers having an increased solubility in ophthalmic device forming material (i.e., ophthalmic device formulations) relative to certain other benzotriazole vinylic monomers and which can be incorporated in materials for ophthalmic devices.

### BACKGROUND

Ocular exposure to ultraviolet light (UV) and high-energy visible light (HEVL) can have a number of negative biological effects. LED lights and electronic devices, including smart phones, computer screens, LCD and LED televisions, can emit violet light (380-450 nm) and blue light (450-495 nm) which wavelengths of light are in the regions that can have negative biological effects to human eyes. To address this potential hazard, efforts have been reported to develop UV/HEVL filtering ophthalmic lenses, such as, spectacles, contact lenses, intraocular lenses, etc. to protect eyes from such light.

Examples of polymeric ophthalmic lens materials that incorporate light absorbing compounds to filter potentially hazardous light can be found in U.S. Pat. Nos. 5,693,095; 8,153,703 and 8,585,938 and U.S. Patent Publication Nos. 2018-0371139 and 2019-0339544.

However, UV/HEVL compounds have a number of competing requirements when incorporating them in ophthalmic devices including having a particular range of UV/HEVL absorption, significant absorption of such light and at a significant rate in the ophthalmic device material, good, uniform incorporation of the UV/HEVL compound in the ophthalmic device material and good solubility in the ophthalmic device forming composition.

Accordingly, there is a continuing need to develop UV/HEVL absorbing compounds that can be readily incorporated in ophthalmic device materials and ophthalmic devices produced therefrom.

### SUMMARY OF THE DISCLOSURE

Advantages of the present disclosure relate to light absorbing benzotriazole monomers having a particular ultraviolet and/or high-energy visible light (UV/HEVL) absorption spectrum that advantageously can have improved solubility in formulations for fabricating ophthalmic devices including silicone hydrogel contact lenses. Such a benzotriazole monomer can be represented by Formula (I) below:

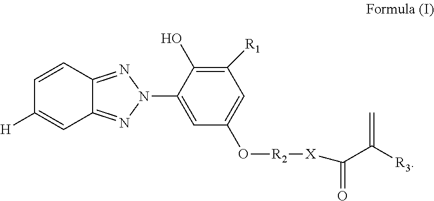

In Formula (I), R₁ represents C₄-C₁₂ t-alkyl; R₂ represents C₄-C₁₂ alkylene, —(R′₂O)ₙ—, wherein R′₂ represents a C₁-C₄ branched or linear alkylene, n is 1, 2, 3 or 4; X represents O or NR when R₂ is C₄-C₁₂ alkylene, otherwise X is a direct bond to R₂ when R₂ is —(R′₂O)ₙ—; R represents H, or a C₁-C₆ alkyl; and R₃ represents H, or CH₃. In some aspects, R₁ represents t-butyl; R₂ represents C₄-C₈ alkylene, or —(CH₂CH₂O)ₙ—, or —(CH₂CH(CH₃)O)ₙ—, n is 2 or 3; and X is O when R₂ represents C₄-C₈ alkylene, or otherwise X is a direct bond to R₂.

Benzotriazole monomers of the present disclosure can be incorporated into ophthalmic device materials and devices by copolymerizing a polymerizable composition including one or more of the benzotriazole monomers of Formula (I) together with one or more vinylic monomers and one or more vinylic crosslinkers that are suitable for forming ophthalmic device materials and devices. Such polymerizable composition can be used to fabricate, for example, UV/HEVL an intraocular lens; a contact lens, such as a hydrogel contact lens; a keratoprosthesis; and a corneal inlay or ring.

In an aspect, an ophthalmic device material and devices therefrom can incorporate one or more of the benzotriazole monomers of the present disclosure together with a vinylic crosslinker and one or more vinylic monomers selected from: (i) one or more hydrophilic vinylic monomers, or (ii) one or more hydrophobic vinylic monomers, or (iii) any combination thereof.

In addition to benzotriazole monomers of the present disclosure, vinylic monomers and vinylic crosslinkers, a polymerizable composition for fabricating ophthalmic device materials and devices can further include other polymerizable components. For example, in addition to benzotriazole monomers of the present disclosure (a first benzotriazole), a polymerizable composition for fabricating ophthalmic device materials and devices can further include one or more other benzotriazoles monomers or other UV and/or HEVL absorbing compounds (a second UV/HEVL compound) that are different than the first benzotriazole of Formula (I). The polymerizable composition can further or alternatively include optional components such as one or more dyes and/or tinting agents.

In another implementations, a process of preparing an ophthalmic device can include copolymerizing a polymerizable composition including a benzotriazole of the present disclosure (e.g., as a first benzotriazole) with a vinylic crosslinker and one or more vinylic monomers selected from: (i) one or more hydrophilic vinylic monomers, or (ii) one or more hydrophobic vinylic monomers, or (iii) any combination thereof. Such a process can occur in a mold for making a contact lens, for example.

Additional advantages of the present disclosure will become readily apparent to those skilled in the art from the following detailed description, wherein only certain aspects are shown and described, simply by way of illustration of carrying out certain subject matter. As will be realized, the invention is capable of other and different embodiments, and its several details are capable of modifications in various respects, all without departing from the invention.

Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 illustrates a general scheme for synthesizing a benzotriazole of the present disclosure.

FIG. 2 is a chart illustrating UV/visible transmission spectra of dilute solutions of benzotriazole compounds as measured in a 1 cm cuvette.

FIG. 3 is a chart illustrating UV/visible transmission spectra of hydrogel contact lenses with and without incorporation of a benzotriazole of the present disclosure as measured in a 1 cm cuvette.

### DETAILED DESCRIPTION OF THE DISCLOSURE

The disclosure may be more fully appreciated by reference to the following description, including the following definitions and examples. Certain features of the disclosed compositions and methods which are described herein in the context of separate aspects, may also be provided in combination in a single aspect. Alternatively, various features of the disclosed compositions and methods that are, for brevity, described in the context of a single aspect, may also be provided separately or in any sub-combination.

Unless otherwise defined herein, scientific and technical terms used in connection with the present application have the meanings that are commonly understood by those of ordinary skill in the art to which this application pertains. Further, unless otherwise required by context, singular terms include pluralities and plural terms include the singular.

As used in the specification including the appended claims, the singular forms “a,” “an,” and “the” include the plural, and reference to a particular numerical value includes at least that particular value, unless the context clearly dictates otherwise.

As used in the specification including the appended claims, when a range of values is expressed, such range includes from the one particular value and/or to the other particular value. All ranges are inclusive and combinable. Further, reference to values stated in ranges includes each and every value within that range.

The term “about” as used herein when referring to a measurable value such as an amount, a temporal duration, and the like, is meant to encompass standard variations of the value as would be understood by those of ordinary skill in the art to which this application pertains as of its earliest filing date.

An “ophthalmic device”, as used herein, refers to a contact lens (hard or soft), an intraocular lens, a corneal onlay, and other ophthalmic devices used on or about the eye or ocular vicinity.

“Contact Lens” refers to a device intended to be worn directly on an eye to correct vision conditions, act as a therapeutic bandage, and/or act as a cosmetic. The device can be made of various polymeric materials and can be fabricated as a soft lens, a hard lens, or a hybrid lens.

A “hydrogel contact lens” refers to a contact lens comprising a hydrogel bulk (core) material. A hydrogel bulk material can be a non-silicone hydrogel material or a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A siloxane, also referred to as a silicone, is an organosilicon group made up of alternating silicon and oxygen atoms. Siloxanes can be linear or cyclic, and usually have one or two organic groups attached to each silicon atom. The basic form of siloxane is one atom of oxygen linked to two atoms of silicon such as shown by: —Si—O—Si— where each Si atom includes one or two organic groups as substituents.

A “silicone hydrogel” or “SiHy” refers to a silicone-containing hydrogel obtained by copolymerization of a polymerizable composition comprising at least one silicone-containing monomer, or at least one silicone-containing macromer, or at least one crosslinkable silicone-containing prepolymer.

As used in this application, the term “non-silicone hydrogel” refers to a hydrogel that is theoretically free of silicon.

“Hydrophilic,” as used herein, describes a material or portion thereof that will more readily associate with water than with lipids. In contrast, and as used herein “hydrophobic” describes a material or portion thereof that will more readily associate with lipids than with water.

The term “room temperature” refers to a temperature of about 22° C. to about 26° C.

A “vinylic monomer” refers to a compound that has one sole ethylenically unsaturated group, and can be polymerized actinically or thermally.

The term “ethylenically unsaturated group” is employed herein in a broad sense and is intended to encompass any groups containing at least one >C≡CH₂ group. Exemplary ethylenically

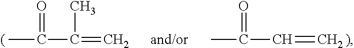

unsaturated groups include without limitation (meth)acryloyl vinyloxycarbonylamino

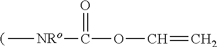

in which R^{∘} is H or C₁-C₄ alkyl), vinyloxycarbonyloxy

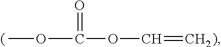

allyl, vinyl, styrenyl, or other C═C containing groups.

As used herein, “actinically” in reference to curing, crosslinking or polymerizing of a polymerizable composition, a prepolymer or a material means that the curing (e.g., crosslinked and/or polymerized) is performed by actinic irradiation, e.g., UV and/or visible light irradiation, or another wavelength range of light. Thermal curing or actinic curing methods are well-known to a person skilled in the art.

An “acrylic monomer” refers to a vinylic monomer having one sole (meth)acryloyl group.

Examples of acrylic monomers include (meth)acryloxy monomer, (meth)acryloyloxy monomers, and (meth)acrylamido monomers.

A “(meth)acryloxy monomer” or “(meth)acryloyloxy monomer” refers to a vinylic monomer having one sole group of

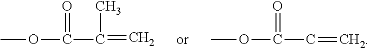

A “(meth)acrylamido monomer” refers to a vinylic monomer having one sole group of

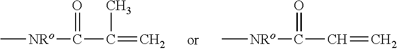

in which R^{∘} is H or C₁-C₄ alkyl.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group

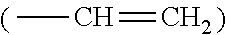

that is directly attached to the nitrogen atom of the amide group.

The term “ene group” refers to a monovalent radical of CH₂═CH— or CH₂═CCH₃— that is not covalently attached to an oxygen or nitrogen atom or a carbonyl group.

An “ene monomer” refers to a vinylic monomer having one sole ene group.

A “vinyloxycarbonylamino monomer” refers to a vinylic monomer having one sole vinyloxycarbonylamino group.

A “vinylaminocarbonyloxy monomer” refers to a vinylic monomer having one sole vinylaminocarbonyloxy group.

A “vinylaminocarbonylamino monomer” refers to a vinylic monomer having one sole vinylaminocarbonylamino group.

A “hydrophilic vinylic monomer” refers to a vinylic monomer which, when polymerized alone, yields a homopolymer that is water-soluble or can absorb at least 10% by weight of water.

However, it is understood that a hydrophilic vinylic monomer can be polymerized with other monomers in which the resulting copolymer may or may not be hydrophilic.

A “hydrophobic vinylic monomer” refers to a vinylic monomer which, when polymerized alone, yields a homopolymer that is insoluble in water and can absorb less than 10% by weight of water. However, it is understood that a hydrophobic vinylic monomer can be polymerized with other monomers in which the resulting copolymer may or may not be hydrophobic.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

A “macromer” or “prepolymer” refers to a compound or polymer that contains multiple ethylenically unsaturated groups and has a number average molecular weight of greater than 700 Daltons.

As used in this application, the term “polymer” means a material formed by polymerizing/crosslinking at least one or more monomers, or one or more macromers or one or more prepolymers or any combinations thereof.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatography) with one or more of a refractive index detector, a low-angle laser light scattering detector, a multi-angle laser light scattering detector, a differential viscometry detector, a UV detector, and an infrared (IR) detector; MALDI-TOF MS (matrix-assisted laser desorption/ionization time-of-flight mass spectroscopy); ¹H NMR (Proton nuclear magnetic resonance) spectroscopy; etc.

A “polysiloxane segment” or “polydiorganosiloxane segment” interchangeably refers to a polymer chain segment (i.e., a divalent radical) of

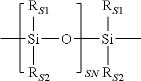

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{∘} (in which alk is C₁-C₆ alkylene diradical, R^{∘} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl; and a photochromic organic radical having a photochromic group.

A “polydiorganosiloxane vinylic monomer” or “polysiloxane vinylic monomer” interchangeably refers to a compound comprising at least one polysiloxane segment and one sole ethylenically-unsaturated groups.

A “polydiorganosiloxane vinylic crosslinker” or “polysiloxane vinylic crosslinker” interchangeably refers to a compound comprising at least one polysiloxane segment and at least two ethylenically-unsaturated groups.

The term “fluid” as used herein indicates that a material is capable of flowing like a liquid.

As used in this application, the term “clear” in reference to a polymerizable composition or ophthalmic device means that the polymerizable composition or ophthalmic device as the case may be is a transparent having a light transmissibility of 85% or greater in the range between 400 to 700 nm.

A free radical initiator can be either a photoinitiator or a thermal initiator. A “photoinitiator” refers to a compound that initiates free radical crosslinking/polymerizing reaction by the use of light. A “thermal initiator” or “thermal free radical initiator” interchangeably refers to a compound that initiates free radical crosslinking/polymerizing reaction by the use of thermal energy.

The term “monovalent radical” and “monovalent group” interchangeably refer to an organic radical or group that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogel atom from an amine), etc.

The term “divalent radical” and “divalent group” interchangeably refer to an organic radical or group that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

The term “silicone hydrogel lens formulation” or “SiHy lens formulation” interchangeably refers to a polymerizable composition that comprises all necessary polymerizable components for producing a SiHy contact lens or a SiHy lens bulk material as well known to a skilled person.

A “UV-absorbing vinylic monomer” refers to a compound comprising one sole ethylenically-unsaturated group and can absorb predominantly UV light in the region between 280 nm to 380 nm.

A “HEVL-absorbing vinylic monomer” refers to a compound comprising one sole ethylenically-unsaturated group and can absorb predominantly HEVL light in the region between 380 nm and 450 nm. It is understood that a HEVL-absorbing vinylic monomer can also absorb UV lights between 280 nm and 380 nm.

“UVA” refers to radiation occurring at wavelengths between 315 and 380 nanometers; “UVB” refers to radiation occurring between 280 and 315 nanometers; “HEVL” refers to radiation occurring at wavelengths between 380 and 450 nanometers.

“UVA transmittance” (or “UVA % T”), “UVB transmittance” or “UVB % T”, and “HEVL-transmittance” or “HEVL % T” are calculated by the following formula.

$$UVA \% T = Average \% Transmission between 315 nm and 380 nm \times 100$$

$$UVB \% T = Average \% Transmission between 280 nm and 315 nm \times 100 ”$$

$$HEVL \% T = Average \% Transmission between 380 nm and 450 nm \times 100$$

$$HEVL \% filtration = 100 \% - HEVL \% T$$

“% T at a wavelength” refers to a percent transmission at the specified wavelength.

Unless indicated otherwise, all ingredient amounts expressed in percentage terms are presented as % w/w.

The present disclosure relates to light absorbing benzotriazole monomers having a particular ultraviolet and/or high-energy visible light (UV/HEVL) absorption spectrum and that advantageously can have improved solubility in formulations (i.e., polymerizable compositions) for fabricating ophthalmic devices including silicone hydrogel contact lenses. Such a benzotriazole monomer can be represented by Formula (I) below:

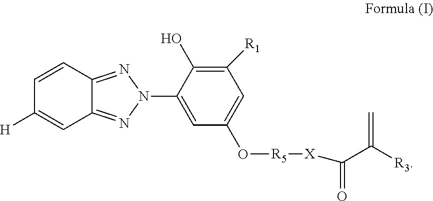

In Formula (I), R₁ represents a C₄-C₁₂ tertiary-alkyl, such as t-butyl; R₂ represents a C₄-C₁₂ alkylene, or a —(R′₂O)ₙ— divalent radical, in which n can be 1, 2, 3 or 4, and R′₂ represents a C₁-C₄ branched or linear alkylene. For example, —(R′₂O)ₙ— can represent a divalent radical of one or more of the following: —(CH₂CH₂O)ₙ—, —(CH₂CH₂CH₂O)ₙ—, and/or —(CH₂CH(CH₃)O)ₙ—, in which n can be 1, 2, 3 or 4. Further in Formula (I), X represents O or NR when R₂ is a C₄-C₁₂ alkylene, otherwise X represents a direct bond to R₂, e.g., when R₂ is —(R′₂O)ₙ—, and R represents H, or a C₁-C₆ alkyl. In addition, R₃ represents H, or CH₃.

In some aspects, the benzotriazole of Formula (I) can have R₁ as a t-butyl group; R₂ as a C₄-C₈ alkylene, or —(CH₂CH₂O)ₙ—, or —(CH₂CH(CH₃)O)ₙ—, n as 2 or 3; and X as O, when R₂ represents a C₄-C₈ alkylene, otherwise X is a direct bond to R₂

In further aspects, the benzotriazole of Formula (I) can be represented by either Formula (II) or Formula (III) below:

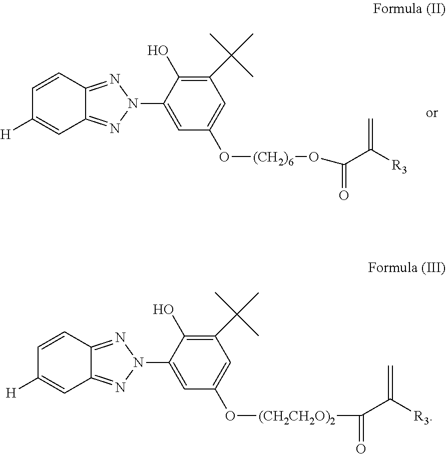

in each of Formulae (II) and (III), R₃ can be H, or CH₃.

It was found that by extending the link between the benzotriazole group and the (meth)acryloyl group, i.e., having a longer R₂ radical, it improved the solubility of the benzotriazole monomer of Formula (I) without significantly adversely affecting the compound's UV/HEVL absorption and significant absorption of such light and at a significant rate in the ophthalmic device material.

As such, a benzotriazole monomer of Formula (I) can be incorporated in an ophthalmic device material and devices therefrom at higher concentrations and in a more uniform distribution throughout the material.

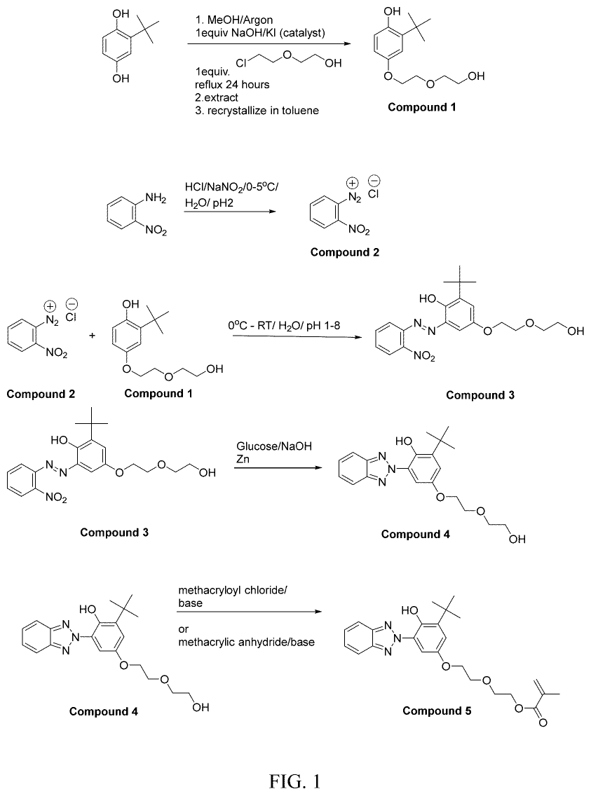

Benzotriazole vinylic monomers of Formula (I) can be prepared using methods described in U.S. Pat. Nos. 4,716,234, 8,153,703, and 8,585,938. For example, a benzotriazole vinylic monomer of Formula (III) in which R₃ is CH₃ can be synthesized according to the scheme shown in FIG. 1.

As shown in FIG. 1, a synthetic pathway can start with the preparation of 2-(tert-butyl)-4-(2-(2-hydroxyethoxy)ethoxy)phenol (Compound 1) by reacting 2-(2-chloroethoxy)ethanol with tert-butylhydroquinone. Additionally, a 2-nitroaniline can be converted to the diazonium salt (Compound 2) which can be azo coupled with Compound 1 followed by reduction of nitro azo intermediate (Compound 3) with glucose and zinc powder, which closes the benzotriazole ring yielding a benzotriazole compound (Compound 4). In the final step, Compound 4 can be reacted with methacryloyl chloride to obtain 2-propenoic acid, 2-methyl-, 2-[2-[3-(2H-benzotriazol-2-yl)-5-(1,1-dimethylethyl)-4-hydroxyphenoxy]ethoxy]ethyl ester (Compound 5, UV30).

It is understood that in the first step in Scheme I, one can substitute 2-(2-chloroethoxy)ethanol (ClC₂H₄OC₂H₄OH) with 6-chloro-1-hexanol, hydroxyethoxy-ethoxyethyl chloride (ClC₂H₄OC₂H₄OC₂H₄OH), or hydroxyethoxyethoxyethoxyethyl chloride (ClC₂H₄OC₂H₄OC₂H₄OC₂H₄OH) to obtain a benzotriazole vinylic monomer of Formula (I) in which R₂ is one of the other recited divalent radicals (groups).

### Ophthalmic Devices

The benzotriazole monomers of the present disclosure can be incorporated into ophthalmic device materials and devices by copolymerizing a polymerizable composition including one or more of the benzotriazole monomers of Formula (I) together with one or more vinylic monomers and one or more vinylic crosslinkers that are suitable for forming ophthalmic device materials and devices. Such polymerizable composition can be used to fabricate, for example, an intraocular lens; a contact lens, such as a hydrogel contact lens; a keratoprosthesis; and a corneal inlay or ring. In some aspects, such a polymerizable composition can include: (a) from about 0.1% to about 5.0% by weight, e.g., from about 0.25% to about 2.5% by weight, of at least one benzotriazole vinylic monomer of Formula (I); (b) from about 99.9% to about 65% by weight of the vinylic monomers and vinylic crosslinkers; and (c) from about 0% to about 30% by weight of optional components, e.g., from about 4% to about 30% of optional components, based on a total weight of the ophthalmic device material or device.

Polymerizable compositions of the present disclosure can be cured thermally or actinically to copolymerize the polymerizable components in the polymerizable composition. In some aspects, the polymerizable composition is dispensed into the mold prior to curing. In such a case, the cured material or device is then demolded and typically extracted with an extraction medium.

In some implementations, the vinylic monomers which can be incorporated into ophthalmic device materials and devices can be selected from: (i) one or more hydrophilic vinylic monomers, or (ii) one or more hydrophobic vinylic monomers, or (iii) any combination thereof.

### Hydrophilic Monomers

For example, hydrophilic vinylic monomers that can be incorporated into ophthalmic device materials and devices by polymerizing or copolymerizing such monomers include, without limitation, N,N-dimethyl (meth)acrylamide, 2-acrylamidoglycolic acid, N-hydroxypropyl (meth)acrylamide, N-hydroxyethyl (meth)acrylamide, N-[tris(hydroxymethyl)-methyl](meth)acrylamide, N-vinylpyrrolidone (NVP), N-vinyl formamide, N-vinyl acetamide, N-vinyl isopropylamide, N-vinyl-N-methyl acetamide (VMA), N-methyl-3-methylene-2-pyrrolidone, 1-methyl-5-methylene-2-pyrrolidone, 5-methyl-3-methylene-2-pyrrolidone, 2-hydroxyethyl (meth)acrylate, hydroxypropyl (meth)acrylate, methoxyethyl (meth)acrylate, trimethylammonium 2-hydroxy propylmethacrylate hydrochloride, aminopropyl methacrylate hydrochloride, dimethylaminoethyl methacrylate (DMAEMA), glycerol methacrylate (GMA), a C₁-C₄-alkoxy polyethylene glycol (meth)acrylate having a weight average molecular weight of up to 1500, polyethylene glycol (meth)acrylate having a weight average molecular weight of up to 1500, methacrylic acid, acrylic acid, methacryloxyethyl phosphocholine, methacryloxypropyl phosphocholine, N-2-hydroxyethyl vinyl carbamate, N-carboxyvinyl-β-alanine (VINAL), N-carboxyvinyl-α-alanine, and mixtures thereof. Such hydrophilic monomers can be used to prepare hydrogel contact lenses such either non-silicone hydrogel contact lenses and silicone hydrogel contact lenses.

### Hydrophobic Vinylic Monomers—Siloxane-Containing Vinylic Monomer

Hydrophobic vinylic monomers that can be incorporated into ophthalmic device materials and devices by polymerizing or copolymerizing such monomers include, without limitation, siloxane-containing vinylic monomers and non-siloxane-containing vinylic monomers such as an alkyl (meth)acrylate.

### Hydrophobic Non-Siloxane Containing Vinylic Monomers

Examples of hydrophobic non-siloxane-containing vinylic monomers that can be incorporated into ophthalmic device materials and devices include, without limitation, C₁-C₁₀ alkyl (meth)acrylate, e.g., methyl (meth)acrylate, ethyl (meth)acrylate, propyl (meth)acrylate, isopropyl (meth)acrylate, 2-ethylhexyl (meth)acrylate, etc., cyclohexyl (meth)acrylate, vinyl acetate, vinyl propionate, vinyl butyrate, vinyl valerate, styrene, chloroprene, vinyl chloride, vinylidene chloride, (meth)acrylonitrile, 1-butene, butadiene, vinyl toluene, vinyl ethyl ether, perfluorohexylethyl-thio-carbonyl-aminoethyl-methacrylate, isobornyl (meth)acrylate, trifluoroethyl (meth)acrylate, hexafluoro-isopropyl (meth)acrylate, hexafluorobutyl (meth)acrylate, and any combination thereof.

### Siloxane-Containing Vinylic Monomers

Examples of siloxane-containing vinylic monomers that can be incorporated into ophthalmic device materials and devices include, without limitation, siloxane-containing (meth)acrylamido monomers, siloxane-containing (meth)acryloxy monomers, siloxane-containing vinyloxy-carbonyloxy monomers, siloxane-containing vinyloxycarbonylamino monomers, siloxane-containing vinylaminocarbonylamino monomers, or siloxane-containing vinylaminocarbonyloxy monomers, each of which comprises a bis(trialkylsilyloxy)alkylsilyl group, a tris(trialkylsilyloxy)-silyl group, or a polysiloxane chain having 2 to 30 siloxane units and terminated with an alkyl, hydroxyalkyl or methoxyalkyl group. Such siloxane-containing vinylic monomers can be obtained from the commercial suppliers, or alternatively prepared according to known procedures, e.g., similar to those described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827, or by reacting a vinylic monomer having a reactive functional group (e.g., an acid chloride, acid anhydride, carboxyl, hydroxyl, amino, epoxy, isocyanate, aziridine, azlactone, or aldehyde group) with a siloxane-containing compound having a reactive group such as a hydroxyalkyl, an aminoalkyl, an alkylaminoalkyl, a carboxyalkyl, an isocyanatoalkyl, an epoxyalkyl, and an aziridinylalkyl, in the presence or absence of a coupling agent under coupling reaction conditions well known to a person skilled in the art.

### Crosslinkers

One or more vinylic crosslinkers can be incorporated into ophthalmic device materials and devices by copolymerizing such crosslinkers with a benzotriazole monomer of Formula (I) together with one or more vinylic monomers. As described earlier, a vinylic crosslinker has at least two ethylenically unsaturated groups and can include a vinylic crosslinking agent, a macromer or prepolymer.

### Polysiloxane Vinylic Crosslinkers

Useful macromer or prepolymer that include siloxanes include polysiloxane vinylic crosslinkers such as α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with amino-functional polydimethylsiloxanes; the reaction products of an azlactone-containing vinylic monomer (any one of those described above for siloxane-containing vinylic monomers) with hydroxyl-functional polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047.

Other examples of polysiloxane vinylic crosslinkers include, without limitation, di-(meth)acryloyloxy-terminated polysiloxane vinylic crosslinkers each having dimethylsiloxane units and hydrophilized siloxane units each having one methyl substituent and one monovalent C₄-C₄₀ organic radical substituent having 2 to 6 hydroxyl groups, more preferably a polysiloxane vinylic crosslinker of formula (H), are described later in this application and can be prepared according to the procedures disclosed in U.S. Pat. No. 10,081,697.

Still further examples of polysiloxane vinylic crosslinkers include vinylic crosslinkers each of which comprises one sole polysiloxane segment and two terminal (meth)acryloyl groups, which can be obtained from commercial suppliers; prepared by reacting glycidyl (meth)acrylate (meth)acryloyl chloride with a di-amino-terminated polydimethylsiloxane or a di-hydroxyl-terminated polydimethylsiloxane; prepared by reacting isocyantoethyl (meth)acrylate with di-hydroxyl-terminated polydimethylsiloxanes prepared by reacting an amino-containing acrylic monomer with di-carboxyl-terminated polydimethylsiloxane in the presence of a coupling agent (a carbodiimide); prepared by reacting a carboxyl-containing acrylic monomer with di-amino-terminated polydimethylsiloxane in the presence of a coupling agent (a carbodiimide); or prepared by reacting a hydroxyl-containing acrylic monomer with a dihydroxy-terminated polydisiloxane in the presence of a diisocyanate or diepoxy coupling agent.

Additional examples of polysiloxane vinylic crosslinkers include chain-extended polysiloxane vinylic crosslinkers each of which has at least two polysiloxane segments linked by a linker between each pair of polysiloxane segments and two terminal ethylenically unsaturated groups, which can be prepared according to the procedures described in U.S. Pat. Nos. 5,034,461, 5,416,132, 5,449,729, 5,760,100, 7,423,074, 8,529,057, 8,835,525, 8,993,651, 9,187,601, 10,301,451, and 10,465,047.

### Non-Silicone Crosslinkers

In addition to, or as an alternative to siloxane-containing crosslinkers, non-siloxane-containing crosslinkers can be incorporated into ophthalmic device materials and devices by copolymerizing such crosslinkers with a benzotriazole monomer of Formula (I) together with one or more vinylic monomers.

Examples of non-silicone vinylic crosslinkers include without limitation ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylene-bis[oxy(2-hydroxypropane-1,3-diyl)]di-(meth)acrylate, bis[2-(meth)acryloxyethyl]phosphate, trimethylolpropane di-(meth)acrylate, and 3,4-bis[(meth)acryloyl]-tetrahydrofuan, diacrylamide, dimethacrylamide, N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamidepropane-2-yl dihydrogen phosphate, piperazine diacrylamide, tetraethyleneglycol divinyl ether, triethyleneglycol divinyl ether, diethyleneglycol divinyl ether, ethyleneglycol divinyl ether, triallyl isocyanurate, triallyl cyanurate, trimethylopropane trimethacrylate, pentaerythritol tetramethacrylate, bisphenol A dimethacrylate, allylmethacrylate, allylacrylate, N-allyl-methacrylamide, N-allyl-acrylamide, or combinations thereof.

### Additional Polymerizable Components

In addition to benzotriazole monomers of the present disclosure, vinylic monomers and vinylic crosslinkers, a polymerizable composition for fabricating ophthalmic device materials and devices can further include other polymerizable components. For example, in addition to benzotriazole monomers of the present disclosure (a first benzotriazole), a polymerizable composition for fabricating ophthalmic device materials and devices can further include one or more other benzotriazoles monomers or other UV and/or HEVL absorbing compounds (a second UV/HEVL compound) that are different than the first benzotriazole of Formula (I). The polymerizable composition can further or alternatively include optional components such as one or more dyes and/or tinting agents. These optional components can be included in a polymerizable composition for fabricating ophthalmic device materials and devices and formed material or device in an amount from 0% to about 30% by weight based on a total weight of the composition, device material or device as the case may be.

### UV/HEVL Monomers

For example, a polymerizable composition for fabricating ophthalmic device materials and devices can further include one or more UV/HEVL compounds of Formula (IV):

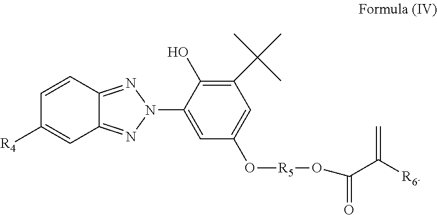

In Formula (IV), R₅ represents a C₁-C₃ alkylene; R₄ represents H, CH₃, CH₃O, F, Cl, Br, I, or CF₃; and R₆ represents H, or CH₃. In some aspects, R₅ represents C₃ alkylene and R₄ represents H, or Cl.

Additional, or alternative, UV-absorbing vinylic monomers can be included in a polymerizable composition of the present disclosure. For example, one or more of the following second benzotriazole-containing vinylic monomers can be included in a polymerizable composition and selected among: 2-(2′-hydroxy-5′-vinyl-phenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropyl-phenyl)-2H-benzotriazole, 2-(2′-hydroxy-5′-acryloxypropyl-phenyl)-2H-benzotriazole, and any combination thereof. In one aspect, the polymerizable composition of the present disclosure includes an UV-absorbing vinylic monomer of 2-[2′-hydroxy-5′-(2-methacryloxyethyl)phenyl)]-2H-benzotriazole. The one or more UV/HEVL compounds (a second UV/HEVL compound, which is different than the benzotriazole of Formula (I)) can be included in the polymerizable composition of the present disclosure, to form an ophthalmic device material or device, as the case may be, in an amount from 0% to about 5% by weight, such as from about 0.1% to about 3.0%, based on a total weight of the composition, device material or device as the case may be.

### Dyes

Dyes and tints can also be included in a polymerizable composition of the present disclosure as optional ingredients. Examples of polymerizable blue dyes include without limitation 1,4-bis(4-(2-methacryloxyethyl)phenylamino) anthraquinone (Reactive Blue 246), 1,4-bis((2-methacryloxy-ethyl)amino)anthraquinone (Reactive Blue 247). An example of a tinting agent includes Cu(II)-phthalocyanine blue pigment particles.

### Initiators

In addition to benzotriazole monomers of the present disclosure, vinylic monomers and vinylic crosslinkers, a polymerizable composition for fabricating ophthalmic device materials and devices can further include a free-radical initiator to facilitate curing the polymerizable composition. Such free radical initiator can be either a photoinitiator, or a thermal initiator, or a combination thereof and can be included in the polymerizable formulation from 0% to about 2% by weight, such as from about 0.25% to about 1.75% by weight, based on a total weight of the polymerizable composition.

### Thermal Free-Radical Initiators

Suitable thermal free-radical initiators include, for example, peroxides, hydroperoxides, azo-bis(alkyl- or cycloalkylnitriles), persulfates, percarbonates, or mixtures thereof. Examples of preferred thermal free-radical initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydro-peroxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof.

### Photoinitiators

In addition, or as an alternative, a photoinitiator can be included in the polymerizable compositions of the present disclosure. Photoinitiators that advantageously generate free radicals for initiating polymerization reaction upon being irradiated with a visible light having a wavelength greater 440 nm are useful for the polymerizable compositions. Examples of photoinitiators include without limitation benzoylphosphine photoinitiators, acyl germanium photoinitiators (i.e., germanium-based Type I photoinitiators as described in U.S. Pat. No. 7,605,190, U.S. Ser. No. 10/533,025, U.S. Ser. No. 11/401,287, and U.S. Ser. No. 10/324,311), acyltin photoinitiators (e.g., tetrakis(2,4,6-trimethylbenzoyl)stannane or photoinitiators described in U.S. Pat. Publ. No. 2023-0364832).

Examples of benzoylphosphine initiators include without limitation 2,4,6-trimethylbenzoyldiphenylphosphine oxide (TPO); 2,4,6-trimethylbenzoylethoxy-phenylphosphine oxide (TPO-L); bis(2,4,6-trimethylbenzoyl)phenylphosphine oxide (BAPO); bis-(2,6-dichlorobenzoyl)-4-N-propylphenyl-phosphine oxide; bis-(2,6-dichlorobenzoyl)-4-N-butylphenylphosphine oxide; lithium phenyl(2,4,6-trimethylbenzoyl) phosphinate (LiTPO).

Examples of acyl germanium photoinitiators include without limitation Bis(4-methoxybenzoyl)diethylgermanium (BMBDE-Ge), dibenzoyldiethylgermanium (DBDE-Ge), tetrakis(2-ethylbenzoyl)-germanium (TEB-Ge).

### Character of Polymerizable Compositions

Advantageously, a polymerizable composition of the present disclosure can be a fluid composition, which facilitates dispensing the composition into a mold for fabricating an ophthalmic device. For example, the polymerizable composition of the present disclosure can be a fluid composition by including a non-reactive diluent such as a solvent to form a solution of the polymerizable composition. Alternatively, the polymerizable composition can be in the form of a solventless blend (i.e., a fluid composition substantially free of any non-reactive diluent, such as a solvent).

Where a polymerizable composition of the present disclosure is a solution, it can be prepared by dissolving all of the components in a suitable solvent for forming an ophthalmic device material or device. Example of suitable solvents include, without limitation, water, lower (e.g., C₁-C₁₀) ethers, glycols, alcohols, ketones, esters, amides, etc. and any mixtures thereof. More particularly, suitable solvents include, without limitation, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl, alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. Preferably, a polymerizable composition is a solution of all the desirable components in water, 1,2-propylene glycol, a polyethyleneglycol having a molecular weight of about 400 Daltons or less, or a mixture thereof.

Where a polymerizable composition of the present disclosure is in the form of a solventless blend, it can be prepared by mixing all components. A solventless polymerizable composition typically comprises at least one blending vinylic monomer as a reactive solvent for dissolving all other polymerizable components of the solventless polymerizable composition and other components. For example many of the lower molecular weight hydrophilic vinylic monomers and/or hydrophobic vinylic monomers described earlier can be used as a solvent for the polymerizable composition. As a particular example, (methyl) methacrylate can be used as a blending vinylic monomer in preparing a solventless polymerizable composition.

### Process of Making Contact Lenses

In certain implementations, one or more of the benzotriazole monomers of the present disclosure can be incorporated into a contact lens, such a hydrogel contact lens, by copolymerizing a polymerizable composition including one or more benzotriazole monomers of Formula (I) together with one or more vinylic monomers and one or more vinylic crosslinker that are suitable for forming a contact lens. The polymerizable composition for forming a contact lens can also include one or more optional components.

In forming a contact lens, generally, a polymerizable composition of the present disclosure can be introduced (dispensed) into a cavity formed by a mold. After introducing the polymerizable composition into the mold, it can be copolymerized (cured) to produce a contact lens. Curing (polymerizing) can be initiated thermally or actinically. After curing, the mold can be opened (i.e., separating the male mold half from the female mold half with the contact lens attached to either the male or female mold halves) and delensing the contact lens (i.e., removing the contact lens from the mold half). The formed lens can be extracted with an extraction medium, typically after delensing. The extraction liquid medium can be any solvent capable of dissolving the diluent(s), unpolymerized polymerizable materials, and oligomers in the formed lens. For example, water, one or more non-reactive solvents described above, or any mixture thereof can be used as the extraction medium. The extracted contact lens can then be hydrated, in the case of forming a hydrogel contact lens. The extracted and/or hydrated hydrogel contact lens can be subjected to further processes, such as, for example, surface treatment, packaging in lens packages with a packaging solution; sterilized such as by autoclaving at from 118 to 124° C. for at least about 30 minutes; and the like.

A more detailed example of preparing a contact lens can include copolymerizing a polymerizable composition including at least one benzotriazole of Formula (I) as a first benzotriazole with one or more vinylic crosslinkers and one or more vinylic monomers selected from: (i) one or more hydrophilic vinylic monomers, or (ii) one or more hydrophobic vinylic monomers, or (iii) any combination thereof. The contact lens can be a hydrogel contact lens such as a silicone hydrogel contact lens depending on the vinylic crosslinker(s) and vinylic monomer(s).

For example, a polymerizable composition for preparing a contact lens can include, based on a total weight of the polymerizable composition: (a) from about 0.1% to about 5% by weight of, such as from about 0.25% to about 2.5% by weight, e.g., from about 0.3% to about 2.5% by weight of, at least one benzotriazole vinylic monomer of Formula (I) (as a first benzotriazole; (b) one or more vinylic crosslinkers and one or more vinylic monomers; such polymerizable monomers can be selected among, for example, a hydrophilic vinylic monomer, a siloxane-containing vinylic monomer, a polysiloxane vinylic crosslinker, a non-silicone vinylic crosslinker, a non-silicone hydrophobic vinylic monomer, and combinations thereof, (c) from about 0.1% to about 2.0% by weight of, such as from about 0.25% to about 1.75% by weight of, at least one free-radical initiator; (d) from 0% to about 3% by weight of, such as from about 0.1% to about 2.0% by weight, e.g., from about 0.3% to about 1.8% by weight of, a second UV/HEVL compound which is different from the first benzotriazole; and (e) an optional blue-tinting agent.

In certain aspects, the polymerizable composition for forming a contact lens can be introduced into a mold, wherein the mold has a first mold half with a first molding surface defining the anterior surface of the contact lens and a second mold half with a second molding surface defining the posterior surface of the contact lens. Further, the first and second mold halves can be configured to receive each other such that a cavity is formed between the first and second molding surfaces. Once introduced into such a mold, the polymerizable composition can be cured thermally or actinically in the mold to form the contact lens incorporating the one or more compounds of Formula (I). Further depending on the amount of the incorporated one or more compounds of Formula (I), and the amount of any additional UV/HEVL compounds, the contact lens can have a HEVL % T of about 35% or less.

Further, numerous contact lens formulations (polymerizable compositions) for making non-silicone hydrogel contact lenses have been described in numerous patents and patent applications published as of the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A. Such non-silicone hydrogel formulations can be used as a base formulation in which at least one benzotriazole vinylic monomer of Formula (I) of the present disclosure is added to such a base formulation to prepare a polymerizable composition, which can be cured to form a non-silicone hydrogel contact lens incorporating the benzotriazole vinylic monomer(s) of Formula (I).

In addition, numerous contact lens formulations (polymerizable compositions) for forming silicone hydrogel contact lenses have been described in numerous patents and patent applications published as of the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. Such silicone hydrogel formulations can be used as a base formulation in which at least one benzotriazole vinylic monomer of Formula (I) of the present disclosure is added to such a base formulation to prepare a polymerizable composition, which can be cured to form a silicone hydrogel contact lens incorporating the benzotriazole vinylic monomer(s) of Formula (I).

Lens molds for making hydrogel contact lenses are well known to a person skilled in the art and, for example, are employed in cast molding or spin casting. For example, a mold (for cast molding) generally comprises at least two mold sections (or portions) or mold halves, i.e., first and second mold halves. The first mold half defines a first molding (or optical) surface and the second mold half defines a second molding (or optical) surface. The first and second mold halves are configured to receive each other such that a lens-forming cavity is formed between the first molding surface and the second molding surface. The molding surface of a mold half is the cavity-forming surface of the mold and in direct contact with the polymerizable composition.

The mold halves can be formed through various techniques, such as injection molding. Methods of manufacturing mold halves for cast-molding a contact lens are generally well known to those of ordinary skill in the art. The process of the present invention is not limited to any particular method of forming a mold. In fact, any method of forming a mold can be used in the present invention. The mold halves can be formed through various techniques, such as injection molding or lathing. Examples of suitable processes for forming the mold halves are disclosed in U.S. Pat. Nos. 4,444,711; 4,460,534; 5,843,446; and 5,894,002.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Hydrogel contact lenses are packaged in individual packages, sealed, and sterilized (e.g., autoclave at 120° C. or higher for at least 30 minutes under pressure) prior to dispensing to users. A person skilled in the art will understand well how to seal and sterilize lens packages.

In a still further aspect, a hydrogel contact lens can include a crosslinked polymeric material incorporating at least one benzotriazole vinylic monomer of Formula (I), (II) and/or (III) (as defined above). Such a hydrogel contact lens can include a crosslinked polymeric material having a polymerized polysiloxane vinylic crosslinker or non-silicone vinylic crosslinker and repeating units of (a) at least one polymerized benzotriazole vinylic monomer of Formula (I), (II) and/or (III) (as defined above); (b) at least one polymerized hydrophilic vinylic monomers, a siloxane-containing vinylic monomers, non-silicone hydrophobic vinylic monomers, and combinations thereof, and (c) one or more optional second UV/HEVL-absorbing vinylic monomer. The contact lens can further, optionally, include Cu(II)-phthalocyanine blue pigment particles distributed therein and/or repeating units of a polymerizable blue dye.

Further, a hydrogel contact lens prepared with a polymerizable composition according to the present disclosure can have at least one property, depending on the vinylic crosslinker(s) and vinylic monomer(s), of: an oxygen permeability of at least about 60 barrers (preferably at least about 70 barrers, more preferably at least about 80 barrers) (at about 35° C.); an elastic modulus of about 1.5 MPa or less (preferably about 1.2 MPa or less, more preferably from about 0.3 MPa to about 1.0 MPa) (at a temperature from about 22° C. to 28° C.); an equilibrium water content of from about 15% to about 75% (preferably from about 20% to about 70%, more preferably from about 25% to about 65%) by weight (at room temperature) when being fully hydrated.

Although various embodiments of the invention have been described using specific terms, devices, and methods, such description is for illustrative purposes only. The words used are words of description rather than of limitation. As would be obvious to one skilled in the art, many variations and modifications of the invention may be made by those skilled in the art without departing from the spirit and scope of the novel concepts of the disclosure. In addition, it should be understood that aspects of the various embodiments of the invention may be interchanged either in whole or in part or can be combined in any manner and/or used together, as illustrated below:
1. A benzotriazole of formula (I):

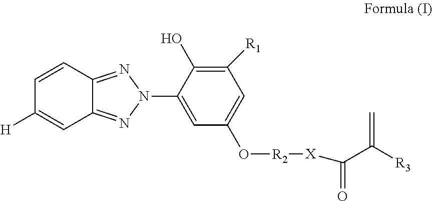

wherein R₁ represents C₄-C₁₂ t-alkyl; R₂ represents C₄-C₁₂ alkylene, —(R′₂O)ₙ—, wherein R′₂ represents a C₁-C₄ branched or linear alkylene, n is 1, 2, 3 or 4; X represents O or NR when R₂ is C₄-C₁₂ alkylene, otherwise X is a direct bond to R₂ when R₂ is —(R′₂O)ₙ—; R represents H, or a C₁-C₆ alkyl; and R₃ represents H, or CH₃.
2. The benzotriazole of embodiment 1, wherein R₁ represents t-butyl; R₂ represents C₄-C₈ alkylene, or —(CH₂CH₂O)ₙ—, or —(CH₂CH(CH₃)O)ₙ—, n is 2 or 3; and X is O when R₂ represents C₄-C₈ alkylene, or otherwise X is a direct bond to R₂.
3. A benzotriazole of Formula (II):

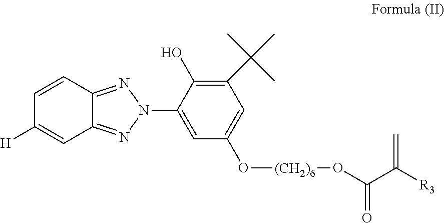

wherein R₃ represents H, or CH₃.
4. A benzotriazole of Formula (III):

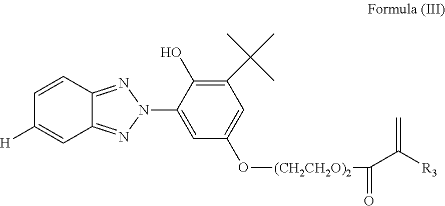

wherein R₃ represents H, or CH₃.
5. An ophthalmic device material incorporating the benzotriazole of any one of embodiments 1-4 as a first benzotriazole.
6. The ophthalmic device material of embodiment 5, further incorporating a UV/HEVL absorbing compound that is different than the first benzotriazole.
7. The ophthalmic device material of embodiment 6, wherein the second benzotriazole has Formula (IV):

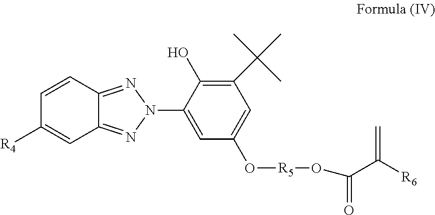

wherein R₅ represents C₁-C₃ alkylene; R₄ represents H, CH₃, CH₃O, F, Cl, Br, I, or CF₃; and R₆ represents H, or CH₃.
8. The ophthalmic device material of any one of embodiments 5-7, further incorporating one or more vinylic crosslinker and one or more vinylic monomers selected from: (i) one or more hydrophilic vinylic monomers, or (ii) one or more hydrophobic vinylic monomers, or (iii) any combination thereof.
9. The ophthalmic device material of any one of embodiments 5-8, wherein the device material incorporates from about 0.1% to about 5% by weight of the first benzotriazole, based on a total weight of the device material.
10. The ophthalmic device material of any one of embodiments 6-9, wherein the device material incorporates from about 0.1% to about 3% by weight of the UV/HEVL absorbing compound, based on a total weight of the ophthalmic device material.
11. The ophthalmic device material of any one of embodiments 8-10, wherein the device material incorporates the crosslinker and the one or more vinylic monomers from about 99.9% to about 65% by weight, based on a total weight of the ophthalmic device material.
12. The ophthalmic device material of any one of embodiments 8-10, wherein the vinylic crosslinker comprises a polysiloxane vinylic crosslinker.
13. The ophthalmic device material of any one of embodiments 8-10, wherein the device incorporates one or more hydrophilic vinylic monomers selected among (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide,), N-2-dimethylaminoethyl (meth)acrylamide, dimethylaminoethyl (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, N-vinyl pyrrolidone, N-vinyl-N-methyl acetamide, N-vinyl formamide, N-vinyl acetamide, N-vinyl isopropylamide, N-vinyl-N-ethyl acetamide, N-vinyl-N-ethyl formamide, 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a weight average molecular weight of up to 1500, methoxy-poly(ethylene glycol)ethyl (meth)acrylamide having a number average molecular weight of up to 1500, allyl alcohol, ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, or any combination thereof.
14. The ophthalmic device material of any one of embodiments 8-10, wherein the device incorporates one or more hydrophobic vinylic monomers comprises one or more siloxane-containing vinylic monomers.
15. The ophthalmic device material of any one of embodiments 5-14, wherein the device further incorporates at least one blue-tinting agent.
16. An ophthalmic device incorporating the device material of any one of embodiments 5-15.
17. An ophthalmic device incorporating the device material of any one of embodiments 5-15, wherein the ophthalmic device is selected from the group consisting of an intraocular lens; a contact lens; a keratoprosthesis; and a corneal inlay or ring.
18. An ophthalmic device incorporating the device material of any one of embodiments 5-15, wherein the ophthalmic device is a hydrogel contact lens.
19. An ophthalmic device incorporating the device material of any one of embodiments 5-15, wherein the ophthalmic device is a silicone hydrogel contact lens.
20. A process of preparing an ophthalmic device, the process comprising:
   copolymerizing a polymerizable composition comprising the benzotriazole of any one of embodiments 1-4 as a first benzotriazole with a vinylic crosslinker and one or more vinylic monomers selected from: (i) one or more hydrophilic vinylic monomers, or (ii) one or more hydrophobic vinylic monomers, or (iii) any combination thereof.
21. The process of embodiment 20, comprising:
   copolymerizing the polymerizable composition in a mold for making a contact lens.
22. The process of embodiment 21, comprising:
   wherein the mold has a first mold half with a first molding surface defining the anterior surface of the contact lens and a second mold half with a second molding surface defining the posterior surface of the contact lens, wherein the first and second mold halves are configured to receive each other such that a cavity is formed between the first and second molding surfaces.
23. The process of any one of embodiments 20-22, wherein the polymerizable composition is copolymerized thermally or actinically.

### EXAMPLES

The following examples are intended to further illustrate certain aspects of the subject technology and are not limiting in nature. Those skilled in the art will recognize, or be able to ascertain, using no more than routine experimentation, numerous equivalents to the specific substances and procedures described herein.

Oxygen Permeability Measurements: Unless specified otherwise, the oxygen transmissibility (Dk/t), the intrinsic (or edge-corrected) oxygen permeability (Dkᵢ or Dk_{c}) of a lens and a lens material are determined according to procedures described in ISO 18369-4.

Equilibrium Water Content: Unless specified otherwise, the equilibrium water content (EWC) of contact lenses are determined as follows. Amount of water (expressed as percent by weight) present in a hydrated hydrogel contact lens, which is fully equilibrated in saline solution, is determined at room temperature. Quickly stack the lenses and transfer the lens stack to the aluminum pan on the analytical balance after blotting lens in a cloth. The number of lenses for each sample pan is typically five (5). Record the pan plus hydrated weight of the lenses. Cover the pan with aluminum foil. Place pans in a laboratory oven at 100±2° C. to dry for 16-18 hours. Remove pan plus lenses from the oven and cool in a desiccator for at least 30 minutes. Remove a single pan from the desiccator, and discard the aluminum foil. Weigh the pan plus dried lens sample on an analytical balance. Repeat for all pans. The wet and dry weight of the lens samples can be calculated by subtracting the weight of the empty weigh pan.

Elastic Modulus: The elastic modulus of a contact lens is determined using a MTS insight instrument. The contact lens is first cut into a 3.12 mm wide strip using Precision Concept two stage cutter. Five thickness values are measured within 6.5 mm gauge length. The strip is mounted on the instrument grips and submerged in PBS (phosphate buffered saline) with the temperature controlled at 21±2° C. Typically 5N Load cell is used for the test. Constant force and speed is applied to the sample until the sample breaks. Force and displacement data are collected by the TestWorks software. The elastic modulus value is calculated by the TestWorks software which is the slope or tangent of the stress vs. strain curve near zero elongation, in the elastic deformation region.

Transmittance: Contact lenses are manually placed into a specially fabricated sample holder or the like which can maintain the shape of the lens as it would be when placing onto eye. This holder is then submerged into a 1 cm path-length quartz cell containing phosphate buffered saline (PBS, pH about 7.0 to about 7.4) as the reference. A UV/visible spectrophotometer, such as, Varian Cary 3E UV-Visible Spectrophotometer with a LabSphere DRA-CA-302 beam splitter or the like, can be used in this measurement. Percent transmission spectra are collected at a wavelength range of 250-800 nm with % T values collected at 1.0 nm intervals. This data is transposed onto an Excel spreadsheet and used to determine if the lenses conform to Class 1 UV absorbance. Transmittance is calculated using the following equations:

$$UVA \% T = Average \% Transmission between 315 nm and 380 nm \times 100$$

$$UVB \% T = Average \% Transmission between 280 nm and 315 nm \times 100$$

$$HEVL \% T = Average \% Transmission between 380 nm and 450 nm \times 100$$

Chemicals: mPDMS represents monomethacryloxypropyl-terminated butyl terminated polydimethylsiloxane (Mw: 600-800 Daltons); MMA represents methyl methacrylate; NVP represents N-vinylpyrrolidone; EGMA represents ethylene glycol methyl ether methacrylate; TEGDMA represents triethyleneglycol dimethacrylate; AMA represents allyl methacrylate; DMA represent N,N-dimethylacrylamide; Norbloc is 2-[2′-hydroxy-5′-(2-methacryloxyethyl)phenyl)]-2H-benzotriazole from Aldrich; PrOH represents n-propanol; UV29 represents 2-propenoic acid, 2-methyl-, 3-[3-(2H-benzotriazol-2-yl)-5-(1,1-dimethylethyl)-4-hydroxyphenoxy]propyl ester; UV30 represents 2-propenoic acid, 2-methyl-, 2-[2-[3-(2H-benzotriazol-2-yl)-5-(1,1-dimethylethyl)-4-hydroxyphenoxy]ethoxy]ethyl ester; RB247 represents 1,4-bis((2-methacryloxyethyl)amino)-anthraquinone (Reactive Blue 247); VAZO 64 represents 2,2′-dimethyl-2,2′azodipropiononitrile; PBS represents a phosphate-buffered saline which has a pH of 7.2±0.2 at 25° C. and contains about 0.044 wt. % NaH₂PO₄·H₂O, about 0.388 wt. % Na₂HPO₄·2H₂O, and about 0.79 wt. % NaCl and 98.78% water; wt. % represents weight percent; “G1” represents a di-methacryloyloxypropyl-terminated polysiloxane (Mn˜7.5-8.1K g/mol, OH content ˜1.25-1.55 mmol/g) of formula (A) shown below.

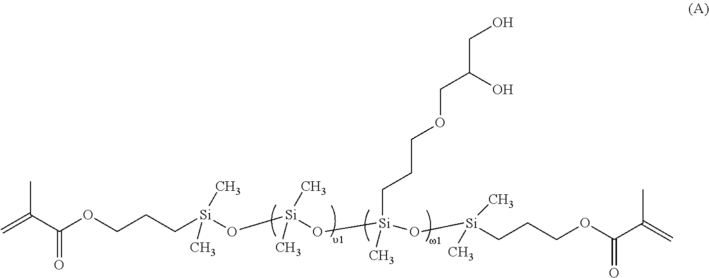

### Melting Point and Solubility of Benzotriazoles

It is reported that there can be a correlation between lower melting points and compound solubility for certain co-crystal drugs and models have been developed to assist in such an analysis (Bathori, N., Acta Cryst., 2014, A70, C990). However, such an approach does not appear universal or necessarily applicable to single crystal compounds. We have found, however, that by extending the linker L in certain benzotriales from —(CH₂)₃— in UV29 to —(CH₂)₂—O—(CH₂)₂— in UV30 lowers the melting point (m.p.) significantly, from 112-113° C. to 63-66° C., respectively. Further, the solubility of UV30, a benzotriazole according to the present disclosure, in 1-propanol is significantly improved, reaching >10.0 mg/mL (Table 1), relative to UV29.

### Table 1. Melting Points and Solubility of Benzotriazoles.

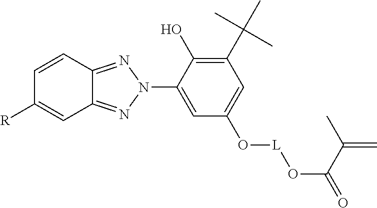

| | UV29 | UV30 |
|---|---|---|
| R group | —H | —H |
| L Linker | —(CH₂)₃— | —(CH₂)₂—O—(CH₂)₂— |
| Melting point (° C.) | 116-118 | 63-66 |
| Solubility in 1-PrOH | 1.7 | >10.0 |
| (mg/mL) | | |

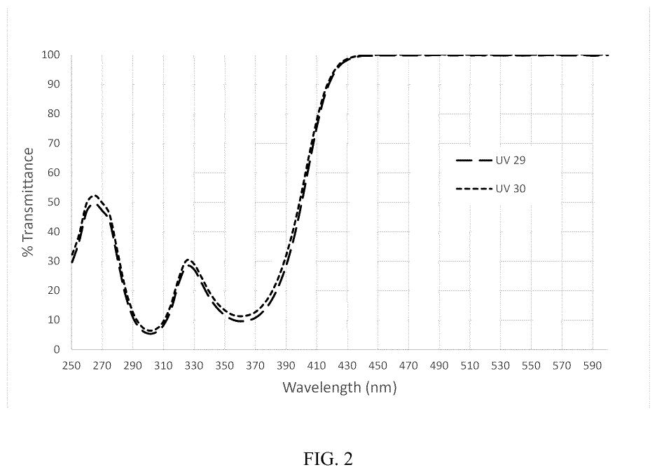

Additionally, extending the linker (L) did not significantly adversely affect the absorbance of the benzotriazole to UV/HEVL light. Transmittance spectra of UV29 and UV30 effectively equivalent, as shown in FIG. 2.

Preparation of Lens Formulations: Silicone hydrogel contact lenses were prepared from polymerizable compositions with and without a benzotriazole of the present disclosure. Polymerizable compositions were prepared with compositions shown in Table 2 below.

### Table 2. Details of Thermally Cured Formulation

| | Control | Example |
|---|---|---|
| Monomer/Macromer | wt % | wt % |
| mPDMS | 33.04 | 32.38 |
| G1 | 5.83 | 5.71 |
| N-Vinyl-2-Pyrrolidone (NVP) | 38.87 | 38.09 |
| Methyl Methacrylate (MMA) | 8.75 | 8.58 |
| Ethylene glycol methyl ether methacrylate | 9.91 | 9.71 |
| (EGMA) | | |
| Trieethylene glycol dimethacrylate (TEGMA) | 0.29 | 0.28 |
| Allyl Methacrylate (AMA) | 0.10 | 0.10 |
| Norbloc | 1.75 | 1.72 |
| VAZO 64 | 0.49 | 0.48 |
| RB247 | 0.01 | 0.01 |
| 2-Methyl-2-Butanol | 0.97 | 0.95 |
| UV30 (a benzotriazole according to the present | 0.0 | 2.00 |
| disclosure) | | |

Lens fabrication (Thermal cure): Lenses were prepared by cast-molding from a polymerizable composition shown in Table 2. The polymerizable composition was introduced into polypropylene molds and thermally cured in an oven under the following curing profile: ramp from room temperature to 55° C. at a ramp rate of about 7° C./minute; holding at 55° C. for about 30 minutes; ramp from 55° C. to 80° C. at a ramp rate of about 7° C./minute; holding at 80° C. for about 30 minutes; ramp from 80° C. to 100° C. at a ramp rate of about 7° C./minute; and holding at 100° C. for about 30 minutes.

After de-molding, cast-molded SiHy contact lenses were extracted with PAA-coating solution for 30 minutes at 40° C. and for 90 min at 40° C. then rinsed in PB (phosphate buffer containing about 0.077 wt. % NaH₂PO₄·H₂O and about 0.31 wt. % Na₂HPO₄·2H₂O) for 15 min. The resultant silicone hydrogel contact lenses were packaged/sealed in polypropylene lens packaging shells (or blisters) (one lens per shell) with 0.65 mL of IPC saline, and then autoclaved (sterilized) at 121° C. for 45 minutes.

PAA-coating solution. A polyacrylic acid (PAA) coating solution is prepared by dissolving an amount of PAA (M.W.: 450 kDa, from Lubrizol) in a given volume of 1-propanol (1-PrOH) to have a concentration of about 0.44% by weight and the pH is adjusted with formic acid to about 2.0.

Preparation of In-Package-Coating solution (IPC saline). Poly(AAm-co-AA) (90/10) partial sodium salt (˜90% solid content, poly(AAm-co-AA) 90/10, Mw 200,000) is purchased from Polysciences, Inc. and used as received. Polyamidoamine epichlorohydrin (PAE) (Kymene, an azetidinium content of 0.46 assayed with NMR) is purchased from Ashland as an aqueous solution and used as received. IPC saline is prepared by dissolving about 0.07% w/w of poly(AAm-co-AA)(90/10) and about 0.10% of PAE (an initial azetidinium millimolar equivalents of about 8.8 millimole) in phosphate-buffered saline (PBS) (about 0.044 w/w % NaH₂PO₄·H₂O, about 0.388 w/w/% Na₂HPO₄·2H₂O, about 0.79 w/w % NaCl) and adjusting the pH to 7.2˜7.6. Then the IPC is heat pre-treated for about 6 hours at about 60° C. (heat pretreatment). During this heat pretreatment, poly(AAm-co-AA) and PAE are partially crosslinked to each other (i.e., not consuming all azetidinium groups of PAE) to form a water-soluble and thermally-crosslinkable hydrophilic polymeric material containing azetidinium groups within the branched polymer network in the IPC saline. After the heat pre-treatment, the IPC is cooled to room temperature then filtered using a 0.22 micron PES membrane filter.

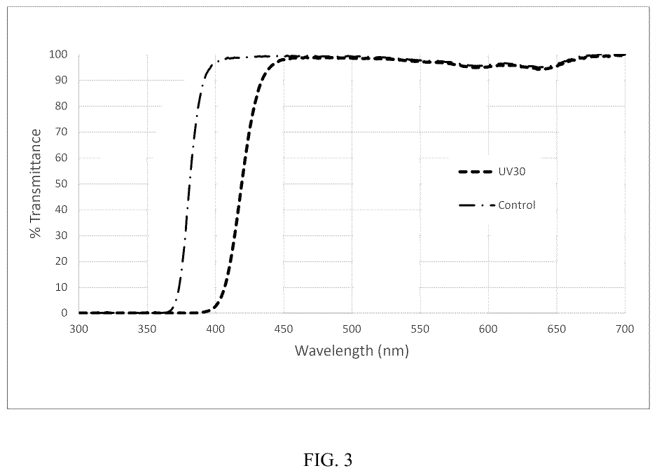

Transmittance spectra of the prepared silicone hydrogel lenses are shown in FIG. 3. As shown in FIG. 3, a benzotriazole monomer of Formula (I) can be incorporated in an ophthalmic device material, e.g., a silicone hydrogel contact lens, and absorb UV/HEVL light relative to a lens without the benefit of the benzotriazole.

Only certain features and aspects of the subject technology and examples of its versatility are shown and described in the present disclosure. It is to be understood that the technology disclosed herein is capable of use in various other combinations and environments and is capable of changes or modifications. Thus, for example, those skilled in the art will recognize, or be able to ascertain, using no more than routine experimentation, numerous equivalents to the specific substances, procedures and arrangements described herein. Such equivalents are considered to be within the scope of the invention and are covered by the following claims.

What is claimed is:

1. A benzotriazole of Formula (I), (II) or (III): 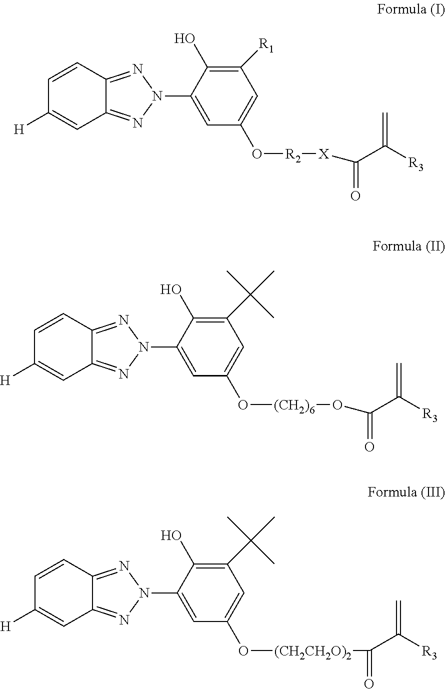
wherein R₁ represents C₄-C₁₂ t-alkyl; R₂ represents C₄-C₁₂ alkylene, —(R′₂O)ₙ—, wherein R′₂ represents a C₁-C₄ branched or linear alkylene, n is 1, 2, 3 or 4; X represents O or NR when R₂ is C₄-C₁₂ alkylene, otherwise X is a direct bond to R₂ when R₂ is —(R′₂O)ₙ—; R represents H, or a C₁-C₆ alkyl; and R₃ represents H, or CH₃.

2. The benzotriazole of claim 1, wherein the benzotriazole is represented by Formula (I) in which R₁ represents t-butyl; R₂ represents C₄-C₅ alkylene, or —(CH₂CH₂O)ₙ—, or —(CH₂CH(CH₃)O)ₙ—, n is 2 or 3; and X is O when R₂ represents C₄-C₈ alkylene, or otherwise X is a direct bond to R₂.

3. The benzotriazole of claim 1, wherein the benzotriazole is represented by Formula (II) in which wherein R₃ represents H, or CH₃.

4. The benzotriazole of claim 1, wherein the benzotriazole is represented by Formula (III) in which R₃ represents H, or CH₃.

5. An ophthalmic device comprising a crosslinked polymeric material that incorporates a first benzotriazole of Formula (I), (II) or (III) 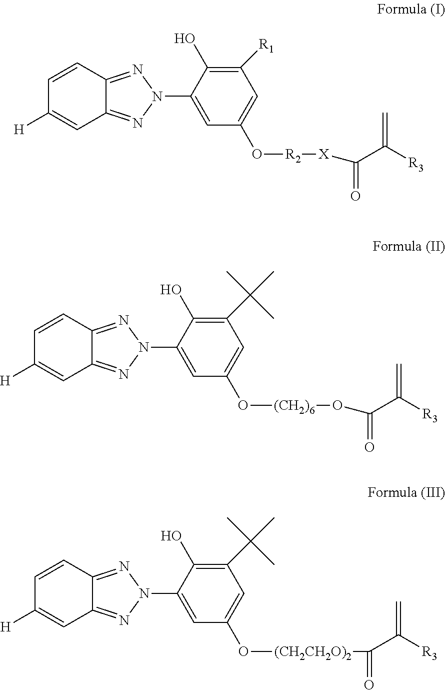
wherein R₁ represents C₄-C₁₂ t-alkyl; R₂ represents C₄-C₁₂ alkylene, —(R′₂O)ₙ—, wherein R′₂ represents a C₁-C₄ branched or linear alkylene, n is 1, 2, 3 or 4; X represents O or NR when R₂ is C₄-C₁₂ alkylene, otherwise X is a direct bond to R₂ when R₂ is —(R′₂O)ₙ—; R represents H, or a C₁-C₆ alkyl; and R₃ represents H, or CH₃,
wherein the ophthalmic device is selected from the group consisting of an intraocular lens; a contact lens; a keratoprosthesis; and a corneal inlay or ring.

6. The ophthalmic device of claim 5, wherein R₁ represents t-butyl; R₂ represents C₄-C₅ alkylene, or —(CH₂CH₂O)ₙ—, or —(CH₂CH(CH₃)O)ₙ—, n is 2 or 3; and X is O when R₂ represents C₄-C₈ alkylene, or otherwise X is a direct bond to R₂.

7. The ophthalmic device of claim 5, wherein the crosslinked polymeric material further incorporates a UV/HEVL absorbing compound that is different than the first benzotriazole.

8. The ophthalmic device of claim 7, wherein the UV/HEVL absorbing compound is a second benzotriazole of Formula (IV): 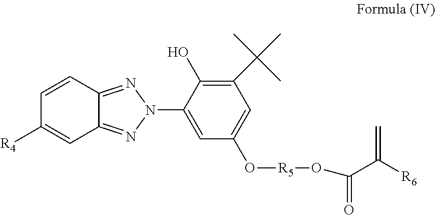
wherein R₅ represents C₁-C₃ alkylene; R₄ represents H, CH₃, CH₃O, F, Cl, Br, I, or CF₃; and R₆ represents H, or CH₃.

9. The ophthalmic device of claim 5, wherein the crosslinked polymeric material further incorporates: (i) one or more hydrophilic vinylic monomers, (ii) one or more hydrophobic vinylic monomers, (iii) one or more vinylic crosslinker, or (iv) any combination thereof.

10. The ophthalmic device of claim 9, wherein the crosslinked polymeric material incorporates a) from about 0.1% to about 5% by weight of the first benzotriazole, based on a total weight of the device material, b) from about 0.1% to about 3% by weight of the UV/HEVL absorbing compound, based on a total weight of the ophthalmic device material, or c) combinations thereof.

11. The ophthalmic device of claim 10, wherein the crosslinked polymeric material incorporates one or more hydrophilic vinylic monomers selected among (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide,), N-2-dimethylaminoethyl (meth)acrylamide, dimethylaminoethyl (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, N-vinyl pyrrolidone, N-vinyl-N-methyl acetamide, N-vinyl formamide, N-vinyl acetamide, N-vinyl isopropylamide, N-vinyl-N-ethyl acetamide, N-vinyl-N-ethyl formamide, 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a weight average molecular weight of up to 1500, methoxy-poly(ethylene glycol)ethyl (meth)acrylamide having a number average molecular weight of up to 1500, allyl alcohol, ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, or any combination thereof.

12. The ophthalmic device of claim 11, wherein the crosslinked polymeric material incorporates at least one polysiloxane vinylic crosslinker and/or at least one siloxane-containing vinylic monomer.

13. The ophthalmic device of claim 10, wherein the crosslinked polymeric material further incorporates at least one blue-tinting agent.

14. The ophthalmic device of claim 5, wherein the ophthalmic device is a hydrogel contact lens.

15. The ophthalmic device of claim 5, wherein the ophthalmic device is a silicone hydrogel contact lens.

16. A process of preparing an ophthalmic device, the process comprising:
copolymerizing a polymerizable composition comprising:
(i) a vinylic crosslinker;
(ii) one or more hydrophilic vinylic monomers;
(iii) optionally one or more hydrophobic vinylic monomers;
(iv) a first benzotriazole of Formula (I), (II) or (III) 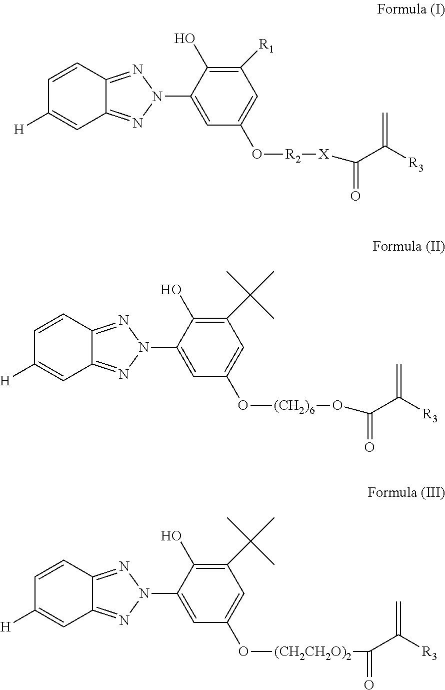
wherein R₁ represents C₄-C₁₂ t-alkyl; R₂ represents C₄-C₁₂ alkylene, —(R′₂O)₁—, wherein R′₂ represents a C₁-C₄ branched or linear alkylene, n is 1, 2, 3 or 4; X represents O or NR when R₂ is C₄-C₁₂ alkylene, otherwise X is a direct bond to R₂ when R₂ is —(R′₂O)₁—; R represents H, or a C₁-C₆ alkyl; and R₃ represents H, or CH₃; and
(v) optionally a second benzotriazole of Formula (IV) 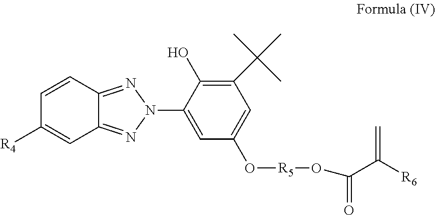
wherein R₅ represents C₁-C₃ alkylene; R₄ represents H, CH₃, CH₃O, F, Cl, Br, I, or CF₃; and R₆ represents H, or CH₃.

17. The process of claim 16, comprising:
copolymerizing the polymerizable composition in a mold for making a contact lens, wherein the mold has a first mold half with a first molding surface defining the anterior surface of the contact lens and a second mold half with a second molding surface defining the posterior surface of the contact lens, wherein the first and second mold halves are configured to receive each other such that a cavity is formed between the first and second molding surfaces, wherein the polymerizable composition is copolymerized thermally or actinically.
